(19) United States
(12) Patent Application Publication
(10) Pub. No.: US 2019/0289204 A1
(43) Pub. Date: Sep. 19, 2019

(54) SYSTEMS AND METHODS FOR TAGGING HIGHLIGHTS WITHIN SPHERICAL VIDEOS

(71) Applicant: GoPro, Inc., San Mateo, CA (US)

(72) Inventor: David Oddy, Oceanside, CA (US)

(21) Appl. No.: 15/861,342

(22) Filed: Jan. 3, 2018

(51) Int. Cl. H04N 5/232; G11B 27/34; G06F 3/01; G06F 3/0346; H04N 13/00; G06K 9/00

(52) U.S. Cl. CPC H04N 5/23238; G11B 27/34; G06F 3/017; G06K 2009/00738; H04N 13/0014; G06K 9/00718; G06F 3/0346

(57) ABSTRACT

Spherical video content may define visual content viewable from a point of view as a function of progress through a progress length of the spherical video content. Presentation of the spherical video content on a display may be effectuated. Pointing information characterizing a user's usage of a pointer with respect to the presentation of the spherical video content may be obtained. The pointer information may indicate particular viewing directions within the spherical video content from the point of view as the function of progress through the progress length of the spherical video content. A viewing direction of an event of interest within the spherical video content from the point of view and a viewing moment within the progress length of the spherical video content at which the event of interest occurs may be identified based on the pointing information.

### FIELD

This disclosure relates to tagging highlights within spherical videos using pointing information.

### BACKGROUND

Interesting moments/objects may be captured within video content. Marking such moments/objects may be cumbersome and/or may distract from enjoyment of consuming the video content.

### SUMMARY

This disclosure relates to tagging highlights within spherical videos. Video information defining spherical video content may be obtained. The spherical video content may have a progress length. The spherical video content may define visual content viewable from a point of view as a function of progress through the progress length of the spherical video content. Presentation of the spherical video content on a display may be effectuated. Pointing information and/or other information may be obtained. The pointing information may characterize a user's usage of a pointer with respect to the presentation of the spherical video content. The pointer information may indicate particular viewing directions within the spherical video content from the point of view as the function of progress through the progress length of the spherical video content. A viewing direction of an event of interest within the spherical video content from the point of view and a viewing moment within the progress length of the spherical video content at which the event of interest occurs may be identified based on the pointing information and/or other information. Storage of the identification of the viewing direction and the viewing moment in a storage medium may be effectuated.

A system for tagging highlights within spherical videos may include one or more of electronic storage, display, processor, and/or other components. In some implementations, the system may further include one or more image capture devices. The display may be configured to present video content and/or other information. The display may include one or more screens for presenting video content. In some implementations, the display may include a head-mounted display and the spherical video content may be presented on the head-mounted display as virtual reality content

An image capture device may include one or more image sensors, one or more optical elements, and/or other components. An image sensor may be configured to generate visual output signals conveying visual information based on light that becomes incident thereon. An optical element may be configured to guide light within a field of view to an image sensor.

The electronic storage may store video information defining video content, and/or other information. Video content may refer to media content that may be consumed as one or more videos. Video content may include one or more videos stored in one or more formats/containers, and/or other video content. Video content may have a progress length. The video content may define visual content viewable as a function of progress through the progress length of the video content. In some implementations, video content may include one or more of spherical video content, virtual reality content, and/or other video content. Spherical video content and/or virtual reality content may define visual content viewable from a point of view as a function of progress through the progress length of the spherical video/virtual reality content.

The processor(s) may be configured by machine-readable instructions. Executing the machine-readable instructions may cause the processor(s) to facilitate tagging highlights within spherical videos. The machine-readable instructions may include one or more computer program components. The computer program components may include one or more of a video information component, a presentation component, a pointing information component, an event of interest component, a storage component, and/or other computer program components.

The video information component may be configured to obtain video information defining one or more spherical video content and/or other information. The video information component may obtain video information from one or more locations. The video information component may be configured to obtain video information defining one or more spherical video content during acquisition of the spherical video content and/or after acquisition of the spherical video content by one or more image sensors.

The presentation component may be configured to effectuate presentation of the spherical video content on the display. In some implementations, presentation of the spherical video content on the display may enable consumption of the spherical video content as virtual reality content. In some implementations, the spherical video content may be presented on the display based on a viewing window and/or other information.

The pointing information component may be configured to obtain pointing information and/or other information. The pointing information may characterize a user's usage of one or more pointers with respect to the presentation of the spherical video content. The pointer information may indicate particular viewing directions within the spherical video content from the point of view as the function of progress through the progress length of the spherical video content. In some implementations, the user's usage of the pointer(s) may include the user making one or more gestures using the pointer(s).

In some implementations, a pointer may include one or more portions of the user's hand. The user's usage of the portion(s) of the user's hand with respect to the presentation of the spherical video content may be determined at least in part on the visual information of the image capture device.

In some implementations, a pointer may include a mobile device. A mobile device may include a remote controller, a smartphone, a smartwatch, a glove, a tracker, and/or other mobile device. The mobile device may include one or more orientation sensors. An orientation sensor may be configured to generate orientation output signals conveying orientation information of the mobile device. The user's usage of the mobile device with respect to the presentation of the spherical video content may be determined at least in part on the orientation information.

The event of interest component may be configured to identify one or more viewing directions of one or more events of interest within the spherical video content from the point of view and one or more viewing moments within the progress length of the spherical video content at which the event(s) of interest occur based on the pointing information and/or other information. In some implementations, the viewing direction may change based on motion of an object captured within the spherical video content.

The storage component may be configured to effectuate storage of the identification of the viewing direction(s) and the viewing moment(s) and/or other information in one or more storage media. The storage component may effectuate storage of the identification of the viewing direction(s) and the viewing moment(s) and/or other information in one or more storage locations including the video information and/or other storage locations.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system that tags highlights within spherical videos.

FIG. 2 illustrates a method for tagging highlights within spherical videos.

FIG. 3 illustrates an example spherical video content.

FIG. 4 illustrates example viewing directions for video content.

FIGS. 5A-5B illustrate example extents of spherical video content.

FIGS. 6A-6B illustrate example usages of a pointer with respect to presentation of spherical video content.

FIG. 7 illustrates example viewing directions of events of interest.

### DETAILED DESCRIPTION

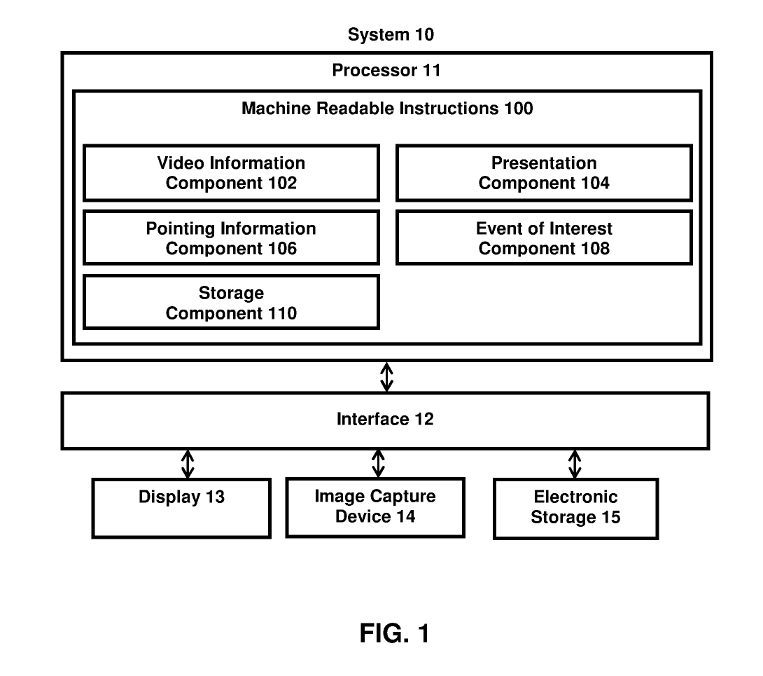

FIG. 1 illustrates a system 10 for tagging highlights within spherical videos. The system 10 may include one or more of a processor 11, an interface 12 (e.g., bus, wireless interface), a display 13, an electronic storage 15, and/or other components. In some implementations, the system 10 may include an image capture device 14. Video information defining spherical video content may be obtained by the processor. The spherical video content may have a progress length. The spherical video content may define visual content viewable from a point of view as a function of progress through the progress length of the spherical video content. Presentation of the spherical video content on the display 13 may be effectuated. Pointing information and/or other information may be obtained by the processor. The pointing information may characterize a user's usage of a pointer with respect to the presentation of the spherical video content. The pointer information may indicate particular viewing directions within the spherical video content from the point of view as the function of progress through the progress length of the spherical video content. A viewing direction of an event of interest within the spherical video content from the point of view and a viewing moment within the progress length of the spherical video content at which the event of interest occurs may be identified based on the pointing information and/or other information. Storage of the identification of the viewing direction and the viewing moment in a storage medium may be effectuated.

The display 13 may be configured to present video content (e.g., spherical video content, virtual reality content) and/or other information. The display 13 may include one or more screens for presenting video content. For example, the display 13 may include a single screen in which the video content is presented. As another example, the display 13 may include multiple screens in which the video content is presented, with individual screens presenting portions of the video content. In some implementations, the display 13 may include a head-mounted display and the video content may be presented on the head-mounted display as virtual reality content

The image capture device 14 may include one or more image sensors, one or more optical elements, and/or other components. The image sensor(s) of the image capture device 14 may be configured to generate visual output signals conveying visual information based on light that becomes incident thereon. The optical element(s) (e.g., lenses, mirrors, prisms, filters, splitters) of the image capture device 14 may be configured to guide light within a field of view to one or more image sensors.

The electronic storage 15 may be configured to include electronic storage medium that electronically stores information. The electronic storage 15 may store software algorithms, information determined by the processor 11, information received remotely, and/or other information that enables the system 10 to function properly. For example, the electronic storage 15 may store information relating to video information, video content, pointing information, pointer, viewing direction, viewing moment, event of interest, and/or other information.

For example, the electronic storage 15 may store video information defining one or more video content and/or other information. Video content may refer to media content that may be consumed as one or more videos. Video content may include one or more videos stored in one or more formats/containers, and/or other video content. A format may refer to one or more ways in which the information defining video content is arranged/laid out (e.g., file format). A container may refer to one or more ways in which information defining video content is arranged/laid out in association with other information (e.g., wrapper format). Video content may include a video clip captured by a video capture device, multiple video clips captured by a video capture device, and/or multiple video clips captured by different video capture devices. Video content may include multiple video clips captured at the same time and/or multiple video clips captured at different times. Video content may include a video clip processed by a video application, multiple video clips processed by a video application and/or multiple video clips processed by different video applications.

Video content may have a progress length. A progress length may be defined in terms of time durations and/or frame numbers. For example, video content may include a video having a time duration of 60 seconds. Video content may include a video having 1800 video frames. Video content having 1800 video frames may have a play time duration of 60 seconds when viewed at 30 frames/second. Other time durations and frame numbers are contemplated.

Video content may define visual content viewable as a function of progress through the progress length of the video content. Visual content of the video content may be included within video frames of the video content. In some implementations, video content may include one or more of spherical video content, virtual reality content, and/or other video content. Spherical video content and/or virtual reality content may define visual content viewable from a point of view as a function of progress through the progress length of the spherical video/virtual reality content.

Spherical video content may refer to a video capture of multiple views from a location. Spherical video content may include a full spherical video capture (360 degrees of capture, including opposite poles) or a partial spherical video capture (less than 360 degrees of capture). Spherical video content may be captured through the use of one or more cameras/image sensors to capture images/videos from a location. For example, multiple images/videos captured by multiple cameras/image sensors may be stitched together to form the spherical video content. The field of view of cameras/image sensor(s) may be moved/rotated (e.g., via movement/rotation of optical element(s), such as lens, of the image sensor(s)) to capture multiple images/videos from a location, which may be stitched together to form the spherical video content. In some implementations, spherical video content may be stored with a 5.2K resolution. Using a 5.2K spherical video content may enable viewing windows for the spherical video content with resolution close to 1080p. In some implementations, spherical video content may include 12-bit video frames. In some implementations, spherical video content may be consumed as virtual reality content.

Virtual reality content may refer to content (e.g., spherical video content) that may be consumed via virtual reality experience. Virtual reality content may associate different directions within the virtual reality content with different viewing directions, and a user may view a particular directions within the virtual reality content by looking in a particular direction. For example, a user may use a virtual reality headset to change the user's direction of view. The user's direction of view may correspond to a particular direction of view within the virtual reality content. For example, a forward looking direction of view for a user may correspond to a forward direction of view within the virtual reality content.

Spherical video content and/or virtual reality content may have been captured at one or more locations. For example, spherical video content and/or virtual reality content may have been captured from a stationary position (e.g., a seat in a stadium). Spherical video content and/or virtual reality content may have been captured from a moving position (e.g., a moving bike). Spherical video content and/or virtual reality content may include video capture from a path taken by the capturing device(s) in the moving position. For example, spherical video content and/or virtual reality content may include video capture from a person walking around in a music festival.

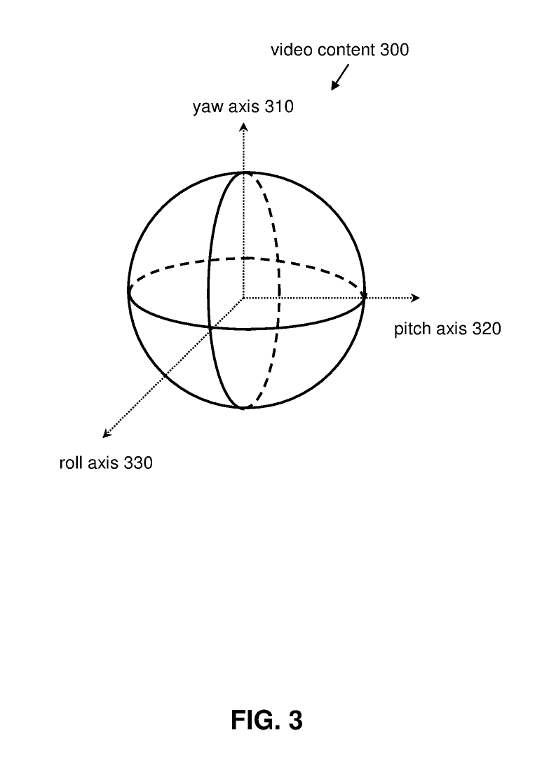

FIG. 3 illustrates an example video content 300 defined by video information. The video content 300 may include spherical video content. The video content 300 may define visual content viewable from a point of view (e.g., center of sphere) as a function of progress through the progress length of the video content 300. FIG. 3 illustrates example rotational axes for the video content 300. Rotational axes for the video content 300 may include a yaw axis 310, a pitch axis 320, a roll axis 330, and/or other axes. Rotations about one or more of the yaw axis 310, the pitch axis 320, the roll axis 330, and/or other axes may define viewing directions/viewing window for the video content 300.

For example, a 0-degree rotation of the video content 300 around the yaw axis 310 may correspond to a front viewing direction. A 90-degree rotation of the video content 300 around the yaw axis 310 may correspond to a right viewing direction. A 180-degree rotation of the video content 300 around the yaw axis 310 may correspond to a back viewing direction. A −90-degree rotation of the video content 300 around the yaw axis 310 may correspond to a left viewing direction.

A 0-degree rotation of the video content 300 around the pitch axis 320 may correspond to a viewing direction that is level with respect to horizon. A 45-degree rotation of the video content 300 around the pitch axis 320 may correspond to a viewing direction that is pitched up with respect to horizon by 45-degrees. A 90 degree rotation of the video content 300 around the pitch axis 320 may correspond to a viewing direction that is pitched up with respect to horizon by 90-degrees (looking up). A −45-degree rotation of the video content 300 around the pitch axis 320 may correspond to a viewing direction that is pitched down with respect to horizon by 45-degrees. A −90 degree rotation of the video content 300 around the pitch axis 320 may correspond to a viewing direction that is pitched down with respect to horizon by 90-degrees (looking down).

A 0-degree rotation of the video content 300 around the roll axis 330 may correspond to a viewing direction that is upright. A 90 degree rotation of the video content 300 around the roll axis 330 may correspond to a viewing direction that is rotated to the right by 90 degrees. A −90-degree rotation of the video content 300 around the roll axis 330 may correspond to a viewing direction that is rotated to the left by 90-degrees. Other rotations and viewing directions are contemplated.

Referring to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine readable instructions 100 to facilitate tagging highlights within spherical videos. The machine readable instructions 100 may include one or more computer program components. The machine readable instructions 100 may include one or more of a video information component 102, a presentation component 104, a pointing information component 106, an event of interest component 108, a storage component 110, and/or other computer program components.

The video information component 102 may be configured to obtain video information defining one or more video content (e.g., spherical video content) and/or other information. Obtaining video information may include one or more of accessing, acquiring, analyzing, determining, examining, loading, locating, opening, receiving, retrieving, reviewing, storing, and/or otherwise obtaining the video information. The video information component 102 may obtain video information from one or more locations. For example, the video information component 102 may obtain video information from a storage location, such as the electronic storage 15, electronic storage of information and/or signals generated by one or more image sensors, electronic storage of a device accessible via a network, and/or other locations. The video information component 102 may obtain video information from one or more hardware components (e.g., an image sensor) and/or one or more software components (e.g., software running on a computing device).

The video information component 102 may be configured to obtain video information defining one or more video content (e.g., spherical video content) during acquisition of the video information and/or after acquisition of the video information by one or more image sensors. For example, the video information component 102 may obtain video information defining a video while the video is being captured by one or more image sensors. The video information component 102 may obtain video information defining a video after the video has been captured and stored in memory (e.g., the electronic storage 15).

The presentation component 104 may be configured to effectuate presentation of the video content (e.g., spherical video content) on the display 13. In some implementations, presentation of spherical video content on the display 14 may enable consumption of the spherical video content as virtual reality content. In some implementations, the spherical video content may be presented on the display 14 based on a viewing window and/or other information. For example, a given visual portion/extent of the video content may be presented on the display 14 based on the viewing window. Such presentation of the video content may provide for a punch-out view of the video content.

A viewing window may define extents of the visual content viewable on the display 13 as the function of progress through the progress length of the video content. The viewing window may define extents of the visual content presented on the display 13 as the function of progress through the progress length of the video content. For spherical video content, the viewing window may define extents of the visual content viewable from the point of view as the function of progress through the progress length of the spherical video content.

The viewing window may be characterized by a viewing direction, a viewing size (e.g., zoom), and/or other information. A viewing direction may define a direction of view for video content. A viewing direction may define the angle/portion of the video content at which the viewing window is directed. A viewing direction may define a direction of view for the video content selected by a user and/or defined by instructions for viewing the video content as a function of progress through the progress length of the video content (e.g., director track specifying viewing directions to be presented during playback as a function of progress through the progress length of the video content). For spherical video content, a viewing direction may define a direction of view from the point of view from which the visual content is defined. Viewing directions for the video content may be characterized by rotations around the yaw axis 310, the pitch axis 320, the roll axis 330, and/or other axes. For example, a viewing direction of a 0-degree rotation of the video content around a yaw axis (e.g., the yaw axis 310) and a 0-degree rotation of the video content around a pitch axis (e.g., the pitch axis 320) may correspond to a front viewing direction (the viewing window is directed to a forward portion of the visual content captured within the spherical video content).

The viewing direction(s) for the video content may be determined based on user input indicating the desired viewing direction(s) (e.g., based on user engagement with a mouse, keyboard, and/or display 13; based on rotation of the display 13, such as a head-mounted display or a mobile device, presenting the video content), based on instructions specifying viewing direction(s) as a function of progress through the progress length of the video content (e.g., director track), based on system default(s), and/or other information.

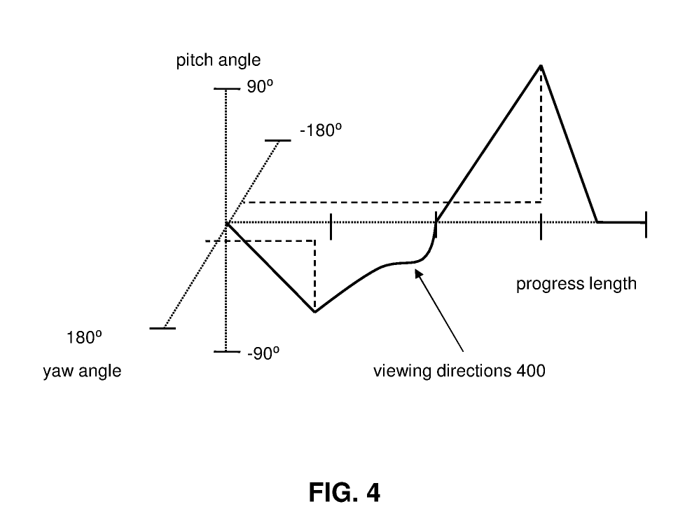

For example, FIG. 4 illustrates example changes in viewing directions 400 (e.g., selected by a user for video content, specified by a director's track) as a function of progress through the progress length of the video content. The viewing directions 400 may change as a function of progress through the progress length of the video content. For example, at 0% progress mark, the viewing directions 400 may correspond to a zero-degree yaw angle and a zero-degree pitch angle. At 25% progress mark, the viewing directions 400 may correspond to a positive yaw angle and a negative pitch angle. At 50% progress mark, the viewing directions 400 may correspond to a zero-degree yaw angle and a zero-degree pitch angle. At 75% progress mark, the viewing directions 400 may correspond to a negative yaw angle and a positive pitch angle. At 87.5% progress mark, the viewing directions 400 may correspond to a zero-degree yaw angle and a zero-degree pitch angle. Other of viewing directions are contemplated.

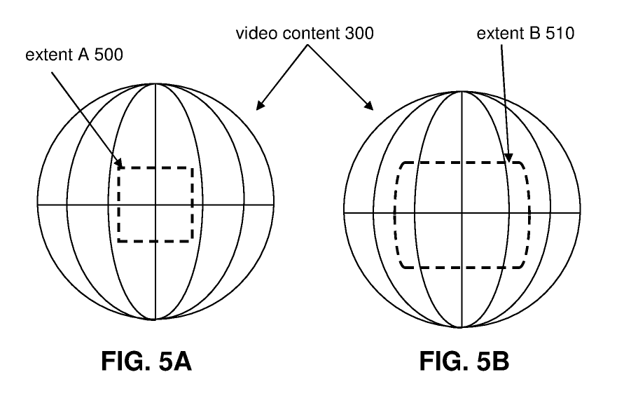

A viewing size may define a size (e.g., zoom, viewing angle) of viewable extents of visual content within the video content. A viewing size may define the dimensions of the viewing window. A viewing size may define a size of viewable extents of visual content within the video content selected by a user and/or defined by instructions for viewing the video content as a function of progress through the progress length of the video content (e.g., director track specifying viewing size to be presented as a function of progress through the progress length of the video content). FIGS. 5A-5B illustrate examples of extents for the video content 300. In FIG. 5A, the size of the viewable extent of the video content 300 may correspond to the size of extent A 500. In FIG. 5B, the size of viewable extent of the video content 300 may correspond to the size of extent B 510. Viewable extent of the video content 300 in FIG. 5A may be smaller than viewable extent of the video content 300 in FIG. 5B.

In some implementations, a viewing size may define different shapes of viewable extents. For example, a viewing window may be shaped as a rectangle, a triangle, a circle, and/or other shapes. In some implementations, a viewing size may define different rotations of the viewing window. A viewing size may change based on a rotation of viewing. For example, a viewing size shaped as a rectangle may change the orientation of the rectangle based on whether a view of the video content includes a landscape view or a portrait view. Other rotations of a viewing window are contemplated.

The pointing information component 106 may be configured to obtain pointing information and/or other information. Obtaining pointing information may include one or more of accessing, acquiring, analyzing, determining, examining, loading, locating, opening, receiving, retrieving, reviewing, storing, and/or otherwise obtaining the pointing information. The pointing information component 106 may obtain pointing information from one or more locations. For example, the pointing information component 106 may obtain pointing information from a storage location, such as the electronic storage 15, electronic storage of information and/or signals generated by one or more sensors (e.g., image sensor, motion sensor, gyroscope, accelerometer, inertial measurement unit), electronic storage of a device accessible via a network, and/or other locations. The pointing information component 106 may obtain pointing information from one or more hardware components (e.g., a sensor) and/or one or more software components (e.g., software running on a computing device).

The pointing information component 106 may be configured to obtain pointing information during acquisition of the pointing information and/or after acquisition of the pointing information by one or more sensors. For example, the pointing information component 106 may obtain pointing information while the motion of a pointer is being captured by one or more sensors. The pointing information component 106 may obtain pointing information after the motion of the pointer has been captured and stored in memory (e.g., the electronic storage 15).

The pointing information may characterize a user's usage of one or more pointers with respect to the presentation of the video content (e.g., spherical video content). A pointer may refer to one or more objects/one or more portions of object(s) which may be pointed/oriented in one or more directions. For example, a pointer may include one or more portions of the user's hand. The user's usage of the portion(s) of the user's hand with respect to the presentation of the video content may be determined at least in part on the visual information of the image capture device 14. That is, the user's hand may be within the field of view of the image capture device 14 and the image(s)/video(s) captured by the image capture device 14 may be analyzed to determine the user's usage of the hand/portion(s) of the hand. That is, how the user is pointing/orienting the hand/portion(s) of the hand may be determined based on the image(s)/video(s) captured by the image capture device 14.

As another example, a pointer may include a mobile device. A mobile device may refer to a computing device that may be carried by a hand. A mobile device may be held by a hand or attached to a hand. For example, a mobile device may include a remote controller, a smartphone, a smartwatch, a glove, a tracker, and/or other mobile device. The mobile device may include one or more orientation sensors. An orientation sensor may be configured to generate orientation output signals conveying orientation information of the mobile device (e.g., with respect to ground). For example, an orientation sensor may include one or more of a motion sensor, a gyroscope, an accelerometer, an inertial measurement unit, and/or other orientation sensor. The user's usage of the mobile device with respect to the presentation of the video content may be determined at least in part on the orientation information. That is, how the user is pointing/orienting the mobile device may be determined based on the orientation information of the orientation sensor(s).

In some implementations, a user's usage of a pointer may be determined based on multiple sensor readings. For example, a pointer may include an orientation sensor and an image capture device may be used to capture the usage of the pointer. The pointing information for the pointer may be determination based on orientation information of the orientation sensor and visual information of the image capture device. Other determinations of pointing information are contemplated.

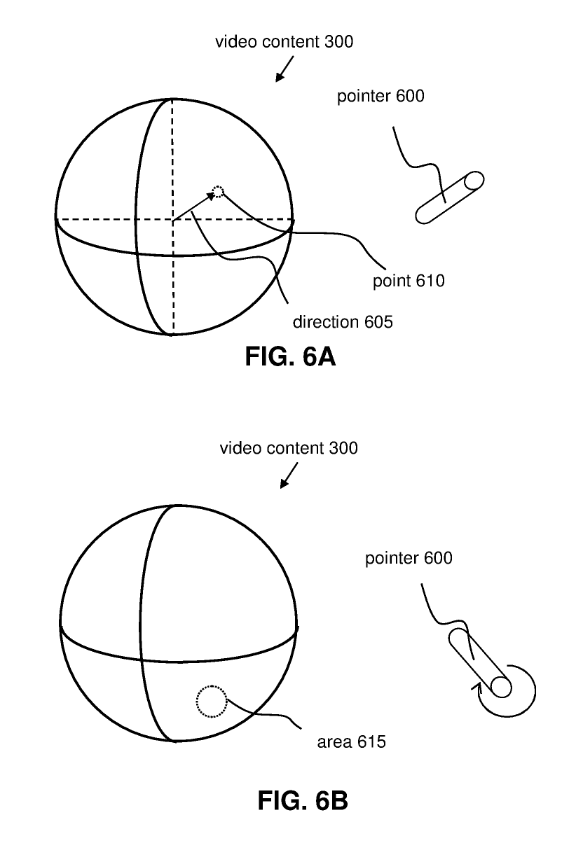

A direction in which the pointer is pointed/oriented may correspond to a direction within the video content. During the presentation of the video content, a user may use the pointer to point at one or more directions within the video content. For example, referring to FIG. 6A, a pointer 600 may be pointed/oriented upwards and to the left. Such a direction of the pointer 600 may correspond to a direction 605 within the video content 300, which may be directed at a point 610 of the video content 300. Referring to FIG. 6B, the pointer 600 may be pointed/oriented upwards and to the left, and then move about in a circular motion. Such a direction of the pointer 600 may correspond to a direction within the video content 300 which marks an area 615 (traces the edges of the area 615) within the video content 300.

The pointer information may indicate particular viewing directions within the video content as the function of progress through the progress length of the video content. For spherical video content, the pointer information may indicate particular viewing directions within the spherical video content from the point of view as the function of progress through the progress length of the spherical video content. The particular viewing directions may correspond to the directions in which the pointer 600 was pointed/oriented in the real world during the presentation of the video content.

In some implementations, the user's usage of a pointer may include the user making one or more gestures using the pointer. A gesture may refer to one or more motions (translational motion, rotational motion) made by the user using the pointer. For example, a user may make with a pointer a particular gesture associated with marking an event of interest within the video content. A user may make with a pointer a particular gesture associated with tagging/selecting an object within the video content. A user may make with a pointer a particular gesture associated with marking an area within the video content. In some implementations, one or more objects within the area may be identified based on computer vision/visual analysis. A user may make with a pointer a particular gesture associated with changing the size/shape of a selected area/object within the video content. Other types of gestures are contemplated.

In some implementations, the user's usage of a pointer may include the user's interaction with the pointer, verbal commands spoken while using the pointer, and/or other information. The user's interaction with a pointer may include the user's use of physical/virtual interfaces of the pointer. For example, the user's usage of the pointer may include the user using a physical/virtual button/switch on the pointer. Such usage of the physical/virtual interfaces of the pointer may allow the user to interact with the presentation of the video content. For example, one or more buttons/switches may be used by the user to indicate the occurrence of an event of interest within the progress length of the video content, with the event of interest marked as occurring at the direction corresponding to the pointing/orientation of the pointer. One or more buttons/switches may be used by the user to tag/select an object within the video content, with the object located within the video content at the direction corresponding to the pointing/orientation of the pointer. One or more buttons/switches may be used by the user to mark an area within the video content and/or to change the size/shape of an area within the video content by changing the pointing/orientation of the pointer. Other interactions with the pointer are contemplated.

The verbal commands spoken while using a pointer may include particular (vocal) sounds made by the user. The sounds may include part of a spoken word/sound, one or more spoken words/sounds, and/or other sounds. The user may use sounds (e.g., speech) to interact with the presentation of the video content. For example, one or more sounds made by the user to indicate the occurrence of an event of interest within the progress length of the video content, with the event of interest marked as occurring at the direction corresponding to the pointing/orientation of the pointer. One or more sounds may be used by the user to tag/select an object within the video content, with the object located within the video content at the direction corresponding to the pointing/orientation of the pointer. One or more sounds may be used by the user to mark an area within the video content and/or to change the size/shape of an area within the video content by changing the pointing/orientation of the pointer. Other verbal commands are contemplated.

The event of interest component 108 may be configured to identify one or more viewing directions of one or more events of interest within the video content and one or more viewing moments within the progress length of the video content at which the event(s) of interest occur based on the pointing information and/or other information. For spherical video content, the event of interest component may identify one or more viewing directions of one or more events of interest within the spherical video content from the point of view and one or more viewing moments within the progress length of the spherical video content at which the event(s) of interest occur based on the pointing information and/or other information.

The event of interest component 108 may identify the viewing moments within the progress length of the video content at which events of interest occur based on particular gestures made by a user using a pointer, based on user's interaction with the pointer, based on verbal command spoken while using the pointer, and/or other information. For example, particular gesture, physical/virtual button/switch press, and/or vocal command may indicate an occurrence of an event of interest within the progress length of the video content at a moment corresponding to when the particular gesture, physical/virtual button/switch press, and/or vocal command was made. The particular gesture, physical/virtual button/switch press, and/or vocal command associated with the occurrence of an event of interest may be general (same gestures, button/switch presses, vocal commands used for different persons) or may be applicable to specific persons (specific gestures, button/switch presses, vocal commands associated with specific persons). A viewing moments may include a point or a duration within the progress length of the video content.

The event of interest component 108 may identify the viewing directions of an event of interest based on the viewing directions indicated by the pointing information. For example, based on a particular moment in the progress length of the video content being identified as a viewing moment at which an event of interest occurs (e.g., based on gestures using a pointer, based on user's interaction with the pointer, based on verbal commands spoken while using the pointer), the viewing directions indicated by the pointing information during the particular moment may be identified as the viewing direction of the event of interest.

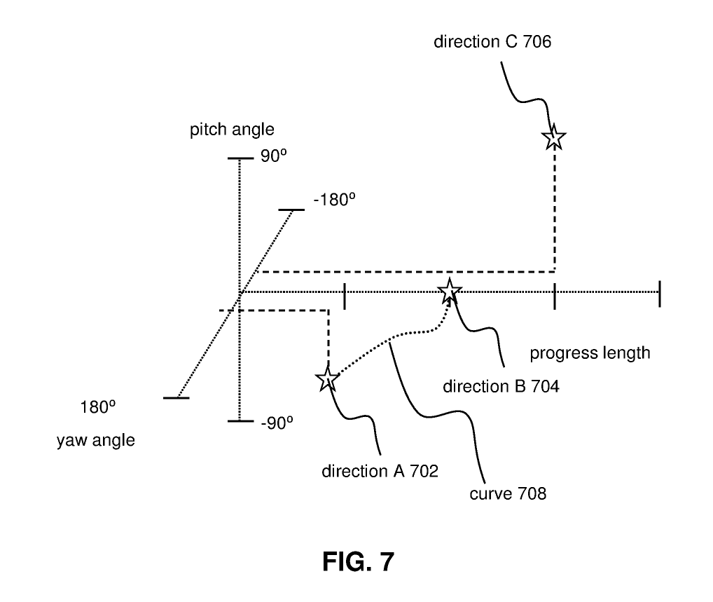

FIG. 7 illustrates example viewing directions of events of interest. For example, three moments within the progress length of the video content may be identified as viewing moments at which events of interest occur: 25% progress mark, 50% progress mark, and 75% progress mark. Based on the viewing direction indicated by the pointing information for the 25% progress mark, the event of interest component 108 may identify the viewing direction of an event of interest to be a positive yaw angle and a negative pitch angle (direction A 702). Based on the viewing direction indicated by the pointing information for the 50% progress mark, the event of interest component 108 may identify the viewing direction of an event of interest to be a zero-degree yaw angle and a zero-degree pitch angle (direction B 704). Based on the viewing direction indicated by the pointing information for the 75% progress mark, the event of interest component 108 may identify the viewing direction of an event of interest to be a negative yaw angle and a positive pitch angle (direction C 706).

As another example, a moment from the 25% progress mark to the 50% progress mark within the progress length of the video content may be identified as a viewing moment at which an event of interest occurs. Based on the viewing direction indicated by the pointing information between the 25% progress mark and the 50% progress mark, the event of interest component 108 may identify the viewing direction of an event of interest to change from a positive yaw angle and a negative pitch angle to a zero-degree yaw angle and a zero-degree pitch angle. The viewing direction of the event of interest may include particular changes indicated by the curve 708. Other identification of viewing directions of events of interest are contemplated.

In some implementations, the viewing direction of an event of interest may change based on motion of an object captured within the video content. For example, an object captured within the video content may be tagged/selected by an user via the pointer as an object of interest (e.g., by using the pointer to point at the object, using the pointer to trace the object, using the pointer to select an area including the object). The viewing direction of the event of interest may be determined to be the direction that includes the object, such that the motion of the object causes the viewing direction to change as a function of progress through the progress length of the video content. That is, a user may tag/select an object within the video content and the viewing direction of an event of interest may follow the object within the video content. For example, referring to FIG. 7, an object that is tagged/selected by a user may be located at direction A 702 at the 25% progress mark. The object may move (the motion indicated by the curve 708) so that it is located at the direction B 704 at the 50% progress mark. The viewing direction of the event of interest may change based on the motion of the object to include the direction A 702, the curve 708, and the direction B 704.

The storage component 110 may be configured to effectuate storage of the identification of the viewing direction(s) and the viewing moment(s) in one or more storage media. The identification of the viewing direction(s) and the viewing moment(s) may be stored with the video content, separately from the video content, and/or in other forms. In some implementations, the identification of the viewing direction(s) and the viewing moment(s) may be stored within a file (e.g., director track) that describes how the video content may be presented during playback.

The storage component 110 may effectuate storage of the identification of the viewing direction(s) and the viewing moment(s) and/or other information in one or more storage locations including the video information, the pointing information, and/or other storage locations. For example, the video information and/or the pointing information may have been obtained from the electronic storage 15 and the identification of the viewing direction(s) and the viewing moment(s) may be stored in the electronic storage 15. In some implementations, the storage component 110 may effectuate storage of the viewing direction(s) and the viewing moment(s) in one or more remote storage locations (e.g., storage media located at/accessible through a server).

In some implementations, the storage component 110 may effectuate storage of the viewing direction(s) and the viewing moment(s) through one or more intermediary devices. For example, the processor 11 may be located within an image capture device without a connection to the storage device (e.g., the image capture device lacks WiFi/cellular connection to the storage device). The storage component 110 may effectuate storage of the identification of the viewing direction(s) and the viewing moment(s) through another device that has the necessary connection (e.g., the image capture device using a WiFi/cellular connection of a paired mobile device, such as a smartphone, tablet, laptop, to store information in one or more storage media). Other storage locations for and storage of the viewing direction(s) and the viewing moment(s) are contemplated.

While the description herein may be directed to video content, one or more other implementations of the system/method described herein may be configured for other types media content. Other types of media content may include one or more of audio content (e.g., music, podcasts, audio books, and/or other audio content), multimedia presentations, images, slideshows, visual content (one or more spherical/non-spherical images and/or videos), and/or other media content.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although the processor 11 and the electronic storage 15 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 15. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11 is shown in FIG. 1 as a single entity, this is for illustrative purposes only. In some implementations, the processor 11 may comprise a plurality of processing units. These processing units may be physically located within the same device, or the processor 11 may represent processing functionality of a plurality of devices operating in coordination. The processor 11 may be configured to execute one or more components by software; hardware; firmware; some combination of software, hardware, and/or firmware; and/or other mechanisms for configuring processing capabilities on the processor 11.

It should be appreciated that although computer components are illustrated in FIG. 1 as being co-located within a single processing unit, in implementations in which processor 11 comprises multiple processing units, one or more of computer program components may be located remotely from the other computer program components.

While computer program components are described herein as being implemented via processor 11 through machine readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 15 may be provided integrally (i.e., substantially non-removable) with one or more components of the system 10 and/or removable storage that is connectable to one or more components of the system 10 via, for example, a port (e.g., a USB port, a Firewire port, etc.) or a drive (e.g., a disk drive, etc.). The electronic storage 15 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 15 may be a separate component within the system 10, or the electronic storage 15 may be provided integrally with one or more other components of the system 10 (e.g., the processor 11). Although the electronic storage 15 is shown in FIG. 1 as a single entity, this is for illustrative purposes only. In some implementations, the electronic storage 15 may comprise a plurality of storage units. These storage units may be physically located within the same device, or the electronic storage 15 may represent storage functionality of a plurality of devices operating in coordination.

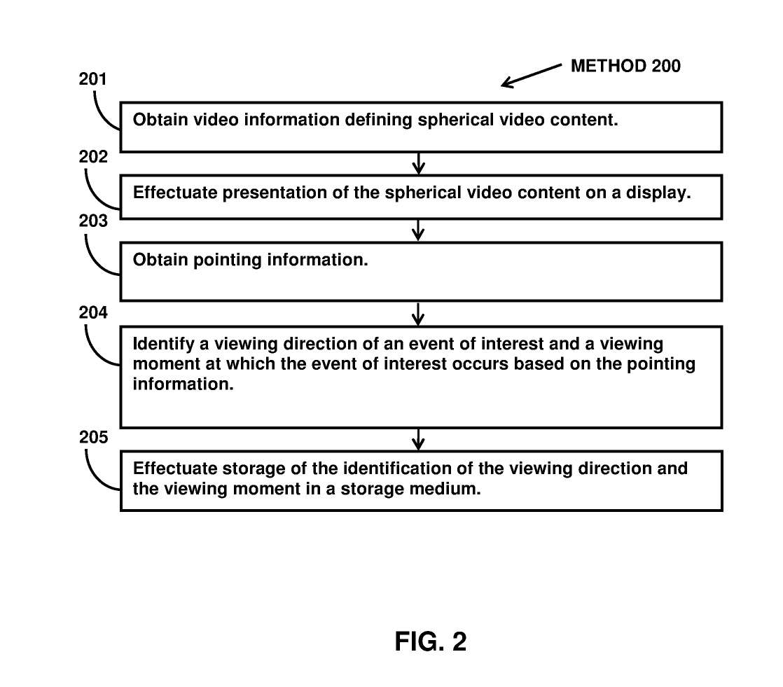

FIG. 2 illustrates method 200 for tagging highlights within spherical videos. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage mediums. The one or more processing devices may include one or more devices configured through hardware, firmware, and/or software to be specifically designed for execution of one or more of the operation of method 200.

Referring to FIG. 2 and method 200, at operation 201, video information defining spherical video content may be obtained. The spherical video content may have a progress length. The spherical video content may define visual content viewable from a point of view as a function of progress through the progress length of the spherical video content. In some implementation, operation 201 may be performed by a processor component the same as or similar to the video information component 102 (Shown in FIG. 1 and described herein).

At operation 202, presentation of the spherical video content on a display may be effectuated. In some implementations, operation 202 may be performed by a processor component the same as or similar to the presentation component 104 (Shown in FIG. 1 and described herein).

At operation 203, pointing information may be obtained. The pointing information may characterize a user's usage of a pointer with respect to the presentation of the spherical video content. The pointer information may indicate particular viewing directions within the spherical video content from the point of view as the function of progress through the progress length of the spherical video content. In some implementations, operation 203 may be performed by a processor component the same as or similar to the pointing information component 106 (Shown in FIG. 1 and described herein).

At operation 204, a viewing direction of an event of interest within the spherical video content from the point of view and a viewing moment within the progress length of the spherical video content at which the event of interest occurs may be identified based on the pointing information. In some implementations, operation 204 may be performed by a processor component the same as or similar to the event of interest component 108 (Shown in FIG. 1 and described herein).

At operation 205, storage of the identification of the viewing direction and the viewing moment in a storage medium may be effectuated. In some implementations, operation 205 may be performed by a processor component the same as or similar to the storage component 110 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system for tagging highlights within spherical videos, the system comprising:
one or more physical processors configured by machine-readable instructions to:
obtain video information defining spherical video content, the spherical video content having a progress length, the spherical video content defining visual content viewable from a point of view as a function of progress through the progress length of the spherical video content;
effectuate presentation of the spherical video content on a display;
obtain pointing information, the pointing information characterizing a user's usage of a pointer with respect to the presentation of the spherical video content, the pointer including a computing device carried by the user's hand, directions in which the pointer is pointed during the presentation of the spherical visual content corresponding to particular viewing directions within the spherical video content from the point of view, the user's usage of the pointer including the user's pointing of the pointer and the user's manipulation of an interface feature of the pointer at a moment during the presentation of the spherical visual content, the pointer information indicating the particular viewing directions within the spherical video content from the point of view as the function of progress through the progress length of the spherical video content and the moment at which the user manipulated the interface feature of the pointer;
identify a viewing moment within the progress length of the spherical video content at which an event of interest occurs based on the moment at which the user manipulated the interface feature of the pointer and a viewing direction of the event of interest within the spherical video content from the point of view based on one or more viewing directions indicated by the pointing information at the moment at which the user manipulated the interface feature of the pointer; and
effectuate storage of the identification of the viewing direction and the viewing moment of the event of interest in a storage medium.

2. The system of claim 1, wherein the display includes a head-mounted display and the spherical video content is presented on the head-mounted display as virtual reality content.

3. The system of claim 1, wherein the user's usage of the pointer includes the user making a gesture using the pointer.

4. The system of claim 1, wherein the pointer includes a mobile device.

5. The system of claim 4, wherein the mobile device includes a remote controller, a smartphone, a smartwatch, a glove, or a tracker.

6. The system of claim 4, wherein the mobile device includes an orientation sensor, the orientation sensor is configured to generate orientation output signals conveying orientation information of the mobile device, and the user's usage of the mobile device with respect to the presentation of the spherical video content is determined at least in part on the orientation information.

7. (canceled)

8. (canceled)

9. The system of claim 1, wherein the viewing direction changes based on motion of an object captured within the spherical video content.

10. A method for tagging highlights within spherical videos, the method performed by a computing device include one or more physical processors, the method comprising:
obtaining, by the computing device, video information defining spherical video content, the spherical video content having a progress length, the spherical video content defining visual content viewable from a point of view as a function of progress through the progress length of the spherical video content;
effectuating, by the computing device, presentation of the spherical video content on a display;
obtaining, by the computing device, pointing information, the pointing information characterizing a user's usage of a pointer with respect to the presentation of the spherical video content, the pointer including a computing device carried by the user's hand, directions in which the pointer is pointed during the presentation of the spherical visual content corresponding to particular viewing directions within the spherical video content from the point of view, the user's usage of the pointer including the user's pointing of the pointer and the user's manipulation of an interface feature of the pointer at a moment during the presentation of the spherical visual content, the pointer information indicating particular viewing directions within the spherical video content from the point of view as the function of progress through the progress length of the spherical video content and the moment at which the user manipulated the interface feature of the pointer;
identifying, by the computing device, a viewing moment within the progress length of the spherical video content at which an event of interest occurs based on the moment at which the user manipulated the interface feature of the pointer and a viewing direction of the event of interest within the spherical video content from the point of view based on one or more viewing directions indicated by the pointing information at the moment at which the user manipulated the interface feature of the pointer; and
effectuating, by the computing device, storage of the identification of the viewing direction and the viewing moment of the event of interest in a storage medium.

11. The method of claim 10, wherein the display includes a head-mounted display and the spherical video content is presented on the head-mounted display as virtual reality content.

12. The method of claim 10, wherein the user's usage of the pointer includes the user making a gesture using the pointer.

13. The method of claim 10, wherein the pointer includes a mobile device.

14. The method of claim 13, wherein the mobile device includes a remote controller, a smartphone, a smartwatch, a glove, or a tracker.

15. The method of claim 13, wherein the mobile device includes an orientation sensor, the orientation sensor is configured to generate orientation output signals conveying orientation information of the mobile device, and the user's usage of the mobile device with respect to the presentation of the spherical video content is determined at least in part on the orientation information.

16. (canceled)

17. (canceled)

18. The method of claim 10, wherein the viewing direction changes based on motion of an object captured within the spherical video content.

19. (canceled)

20. (canceled)

21. The system of claim 1, wherein the viewing direction of the event of interest is identified to include the one or more viewing directions indicated by the pointing information at the moment at which the user manipulated the interface feature of the pointer.

22. The system of claim 22, wherein the one or more viewing directions define a curve of viewing direction as the function of progress through the progress length of the spherical video content.

23. The system of claim 1, wherein the viewing direction of the event of interest is identified to include an area of the spherical video content defined by the one or more viewing directions indicated by the pointing information at the moment at which the user manipulated the interface feature of the pointer.

24. The system of claim 23, wherein the one or more viewing directions indicated by the pointing information trace edges of the area.

25. The system of claim 23, wherein visual analysis of the spherical video content within the area is performed to identify an object within the area.

26. The system of claim 23, wherein a size and/or a shape of the area is changed based on the user's usage of the pointer.
